(19) United States
(12) Patent Application Publication
(10) Pub. No.: US 2026/0075138 A1
(43) Pub. Date: Mar. 12, 2026

(54) CHATBOT CREATION USING INTERACTIVE VOICE RESPONSE TREES

(71) Applicant: INTERNATIONAL BUSINESS MACHINES CORPORATION, Armonk, NY (US)

(72) Inventors: Aharon Satt, Kiryat Tivon (IL); Assaf Arbelle, Lehvot Haviva (IL)

(21) Appl. No.: 18/826,832

(22) Filed: Sep. 6, 2024

(51) Int. Cl. H04M 3/493; G06Q 10/0637; G10L 15/22

(52) U.S. Cl. CPC H04M 3/4936; G06Q 10/06375; G10L 15/22; G10L 2015/228

(57) ABSTRACT

A chatbot system includes a computer hardware system for implementing a chatbot and a hardware processor configured to initiate the following executable operations. A user prompt associated with a user and directed to the chatbot is received from a client device. An interactive voice response (IVR) tree associated with the user prompt is identified. The user prompt and the IVR tree are encoded into an encoded input. The encoded input is consumed by a trained neural model, and the neural model generates, using the encoded input, business process information. The trained neural model generates, using the business process information, an answer, and the answer is provided to the client device.

### BACKGROUND

The present invention relates to artificial intelligence, and more specifically, to generating artificial intelligence-driven chatbots using interactive voice response trees.

Organizations that offer products and services to customers typically rely on call centers and interactive voice response (IVR) systems to interact with their customers. IVR systems are configured to provide customers with requested information and perform routine account actions. Basic forms of IVR systems employ data structures commonly referred to as IVR trees. An example of an IVR tree 100 is illustrated in FIG. 1. A user navigates down the IVR tree 100 by providing inputs via touch tones and/or spoken keywords. A user's navigation through an IVR tree 100 is limited by the way the IVR tree 100 is structured. This type of human-machine interaction typically requires multiple question-answering turns to capture user servicing intent, obtain the necessary user inputs, and then implement the required action. Consequently, the use of IVR is considered tedious, time-consuming and not user-friendly.

There are several common terms used in IVR systems. For example, “intents” are purposes or goals that are expressed in a customer's input, such as answering a question or processing a bill payment. For example, an intent may be to make a reservation at a restaurant.

The term “slot” is information that is required to achieve an intent. Other art-recognized terms for a slot include a parameter, entity, concept, and a variable. In an example in which a user attempts to make a restaurant reservation, the slots could be: (i) name of the restaurant, (ii) location of the restaurant if more than one restaurant exists for the name, (iii) the day/time of the reservation, (iv) the number of people in the reservation, (v) additional information (e.g., allergies, preference as to a particular table such as by the window or inside versus outside, birthday, anniversary, etc.).

The term “slot type” is defined as the kind (or type) of information that a slot can have. Other art-recognized terms for a slot type include an entity type, entity name, primitive type, and variable type. In the example described above, the kind of information for the number of people in the reservation would be a number and the kind of information for the location would be an address.

The term “slot value” is defined as the actual value for a particular slot. Slot values are the particular data associated with a particular slot. Other art-recognized terms for a slot value include an entity entry, entity value, and symbol. In the example described above, the slot value for the location could be “downtown,” the day/time could be “tomorrow at 8” and the number of people in the reservation could be “for me and my husband.”

As an alternative to voice-based communication systems, some enterprises provide automated systems for these interactions, such as artificial intelligence (AI)-driven computer programs called “chatbots,” which are configured to conduct conversations with humans over text chat or voice in order to provide information and/or to perform certain services. Chatbots offer several advantages over traditional IVR systems, such as allowing users to express their servicing intention using natural language, either in text or speech. Chatbots are typical neural models, such as a Large Language Model (LLM). LLMs are a class of foundation models, which is a type of large-scale, general purpose AI model that can be adapted to perform a variety of different activities. Foundation models are typically trained on large amounts of generalized and unlabeled data to provide the foundational capabilities needed to supply multiple use cases and applications, as well as resolve a multitude of tasks. In the past, LLMs have been used for natural-language processing, but they can also be used, among other things, to generate answers in response to user inputs (prompts).

Chatbots, since they are trained on generalized data, tend to not be repeatable in that a given user prompt may result in the generation by the chatbot of different and/or incorrect answers. Consequently, specialized (domain-specific) chatbots intended to address specific situations must be trained with specialized knowledge in order perform their intended functionality. In the context of replacing a traditional IVR system, the chatbot would need to be trained to respond to the specific requests that would normally by handled by the traditional IVR system. While there are approaches that are able to incorporate information such as intents and slots into a chatbot, these approaches are time consuming and must be performed for each IVR system being replaced.

### SUMMARY

A method is performed within and by a chatbot system for implementing a chatbot. A user prompt associated with a user and directed to the chatbot is received from a client device. An interactive voice response (IVR) tree associated with the user prompt is identified. The user prompt and the IVR tree are encoded into an encoded input. The encoded input is consumed by a trained neural model, and the neural model generates, using the encoded input, business process information. The trained neural model generates, using the business process information, an answer, and the answer is provided to the client device.

Additionally, with the method, the business process information includes at least one intent, at least one slot, and at least one action, and the chatbot system is configured to perform the at least one action. The neural model is a large language model (LLM). The trained neural model is trained by inputting into the trained neural model a plurality of IVR trees and training user prompts associated therewith and the trained neural model is configured to generate predicted business process information. A loss function compares the predicted business process information to expected business process information. Additionally, the trained neural model can be configured to generate a predicted path for a training user prompt associated with a particular training IVR tree, and the loss function is based upon comparing the predicted path with an expected path.

A computer hardware system including a chatbot of a chatbot system includes a hardware processor configured to initiate the following operations. A user prompt associated with a user and directed to the chatbot is received from a client device. An interactive voice response (IVR) tree associated with the user prompt is identified. The user prompt and the IVR tree are encoded into an encoded input. The encoded input is consumed by a trained neural model, and the neural model generates, using the encoded input, business process information. The trained neural model generates, using the business process information, an answer, and the answer is provided to the client device.

Additionally, with the computer hardware system, the business process information includes at least one intent, at least one slot, and at least one action, and the chatbot system is configured to perform the at least one action. The neural model is a large language model (LLM). The trained neural model is trained by inputting into the trained neural model a plurality of IVR trees and training user prompts associated therewith and the trained neural model is configured to generate predicted business process information. A loss function compares the predicted business process information to expected business process information. Additionally, the trained neural model can be configured to generate a predicted path for a training user prompt associated with a particular training IVR tree, and the loss function is based upon comparing the predicted path with an expected path.

A computer program product comprises a computer readable storage medium having stored therein program code. The program code, which when executed by a computer hardware system of a chatbot system including a chatbot, causes the computer hardware system to perform the following. A user prompt associated with a user and directed to the chatbot is received from a client device. An interactive voice response (IVR) tree associated with the user prompt is identified. The user prompt and the IVR tree are encoded into an encoded input. The encoded input is consumed by a trained neural model, and the neural model generates, using the encoded input, business process information. The trained neural model generates, using the business process information, an answer, and the answer is provided to the client device.

Additionally, with the computer program product, the business process information includes at least one intent, at least one slot, and at least one action, and the chatbot system is configured to perform the at least one action. The neural model is a large language model (LLM). The trained neural model is trained by inputting into the trained neural model a plurality of IVR trees and training user prompts associated therewith and the trained neural model is configured to generate predicted business process information. A loss function compares the predicted business process information to expected business process information. Additionally, the trained neural model can be configured to generate a predicted path for a training user prompt associated with a particular training IVR tree, and the loss function is based upon comparing the predicted path with an expected path.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is an example of an IVR tree.

FIG. 2 is a block diagram illustrating an example architecture of a chatbot system and chatbot server according to an embodiment of the present invention.

FIGS. 3A, 3B are block diagrams illustrating different chatbot training architectures according to embodiments of the present invention

FIG. 4 is a block diagram illustrating a methodology of employing the chatbot training architecture 300 of FIGS. 3A-B to train a neural model as a chatbot according to an embodiment of the present invention.

FIG. 5 is a block diagram illustrating a methodology of employing the chatbot server 210 of FIG. 1 to act as a chatbot according to an embodiment of the present invention.

FIG. 6 is a block diagram illustrating an example of a computer environment for implementing portions of the methodology of FIGS. 4 and 5.

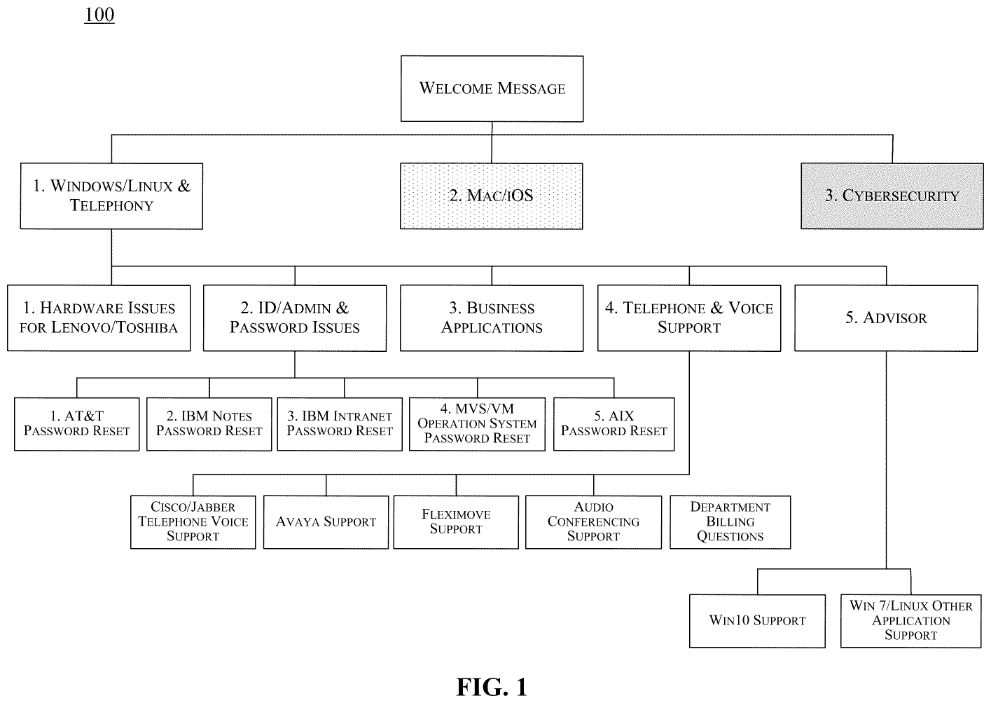

### DETAILED DESCRIPTION

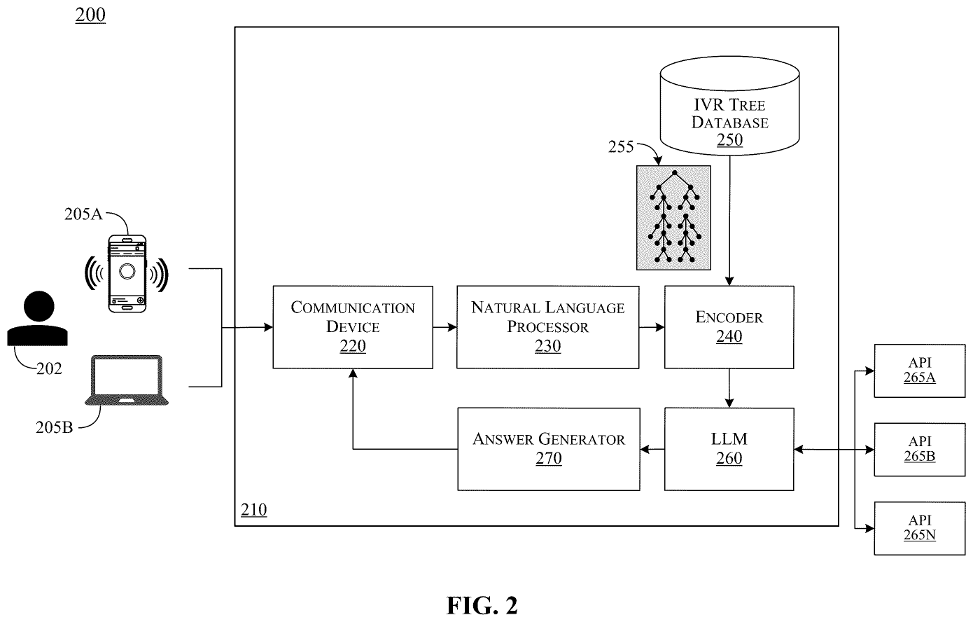

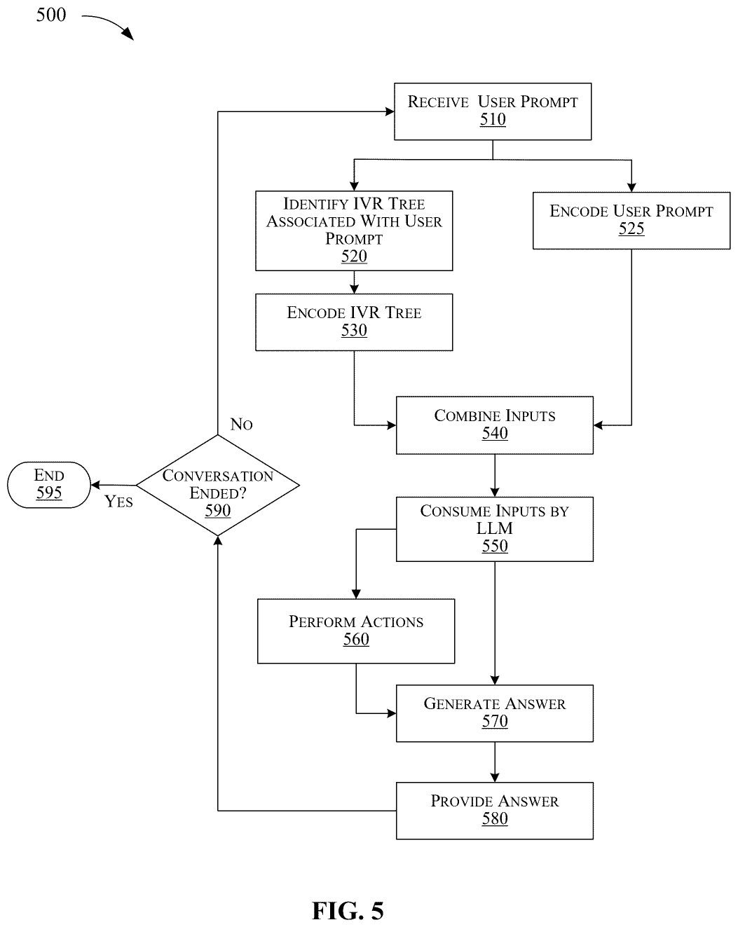

Referring generally to FIGS. 2 and 5, a chatbot system 200 and methodology 500 is disclosed. In general, the chatbot system 200 includes a chatbot server (also referred to as “chatbot”) 210 and is configured to perform the following. A user prompt associated with a user 202 and directed to the chatbot server 210 is received from a client device 205A-B. An interactive voice response (IVR) tree 255 associated with the user prompt is identified, and the user prompt and the IVR tree 255 are encoded into an encoded input. This encoded input is then consumed by a trained neural model, such as a large language model (LLM) 260, and the neural model generates, using the encoded input, business process information. The trained neural model, such as the answer generator 270, also generates, using the business process information, an answer, and the answer is provided to the client device 205A-B.

The chatbot system 200 and methodology 500 described herein provide specific improvements over prior chatbot systems 200. Specifically, the chatbot system 200 can leverage one or more previously-generated IVR trees 255 to create a virtual assistant that can provide zero-shot capabilities without a need to individually train a neural model for the specifical IVR tree being used. Other advantages are provided as evident from the disclosure herein.

More specifically, the chatbot system 200 involves a user 202 communicating with the chatbot server 210 using audio (e.g., by speaking over a phone 205A) or text (e.g., with the use of a client computer 205B, such as a laptop, desktop, smartphone, etc.). Although not limited in this manner, the chatbot server 210 includes a communication device 220 configured to interact with the user devices 205A-B. The user interactions with the chatbot server 210 take the form of user prompts, which can be audio and/or textual. Additionally, the chatbot server 210 includes neural models, which are a type of artificial intelligence. These neural models can include a natural language processor 230, answer generator 270, and LLM 260. While shown separately, one or more of these individual components 230, 270, 260 can be combined into a single component that provides the same functionality. Consequently, any reference herein to LLM 260 can also applying to the natural language processor 230 and the answer generator 270.

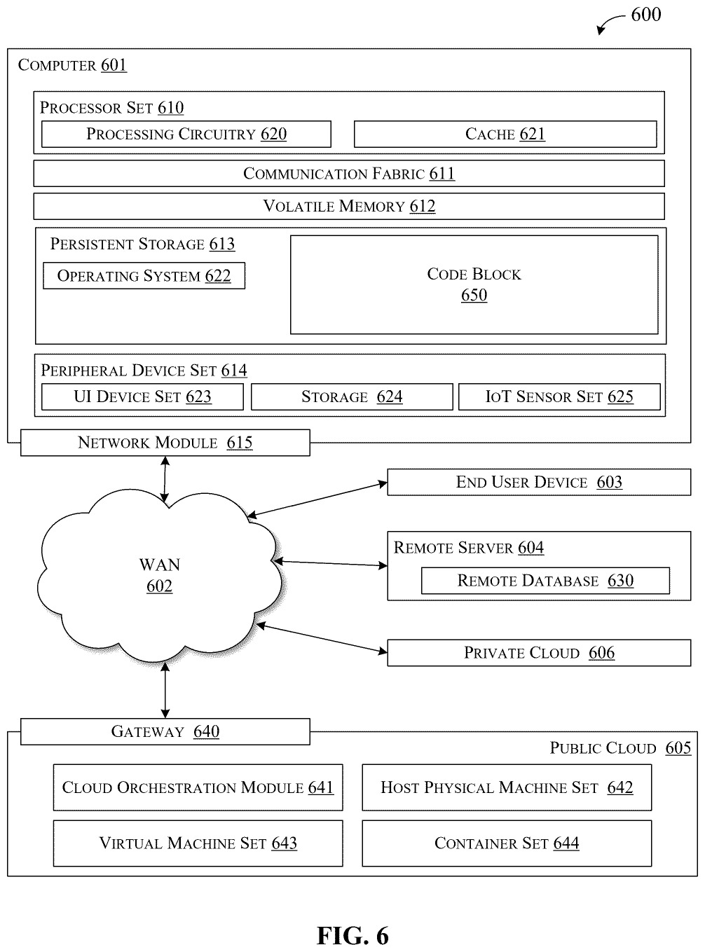

The LLM 260 can be configured to communicate with one or more APIs 265A-N, which are application programming interfaces that provide specific functionality, such a providing information requested by the LLM 260. The chatbot server 210 can also include an IVR tree database 250 and encoder 240. Any of the IVR tree database 250, encoder 240, or APIs 265A-N can be found within the chatbot server 210 or found external to the chatbot server 210. For example, these components can be provided as software as a service (SaaS) components, as discussed with respect to FIG. 6.

By training the LLM 260 using IVR trees and sample user inputs, the LLM 260 can acquire “zero shot capabilities.” As is known in the art, the term zero shot capability refers to the ability of an LLM to provide a correct answer to an input that the LLM has never seen before. This zero shot capability is obtained by both training the LLM 260 using sample IVR trees as contextual input that accompanies the user prompts and providing the trained LLM 260 with the actual LLM tree 255 that is associated with the particular user prompt received by the user 202.

More specifically, in 510, a user input from a user device 205A-B associated with a user 202 is received by the chatbot server 210 via the communication device 220. The manner in which the chatbot servers 210 is not limited as to any approach, previously known or otherwise.

In 520, an IVR tree 255 associated with the user prompt is identified, and the manner in which the IVR tree 255 is identified from the user prompt is not limited as to a particular approach. For example, the chatbot server 210 may be configured to support a single IVR tree 255, and in that situation, the single IVR tree 255 is presumptively identified. In another example, if the chatbot server 210 supports multiple different IVR trees 255 if the user prompt is directed to a particular web-based application, the identity of the web-based application to which the user prompt is directed may indicate the particular IVR tree 255 associated with the user prompt. In another example, the particular phone number called by the user device 205A-B may indicate the particular IVR tree 255 associated with the user prompt. The particular approaches described herein are exemplary and not representative of all of the possible different approaches.

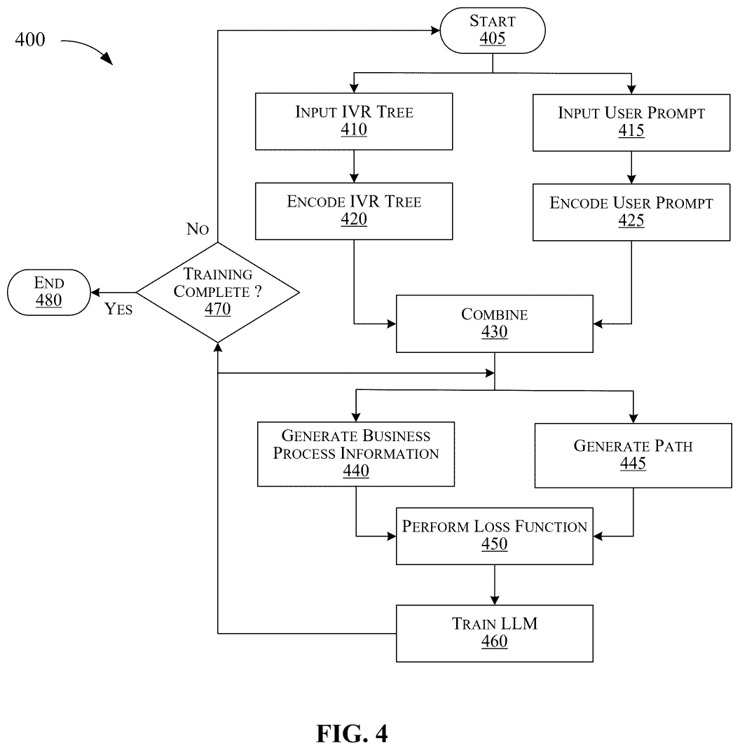

In 525, the encoder 240 is used to encode the IVR tree 255 and the user prompt in a manner that can be read by the LLM 260. Although shown as being performed by a single encoder 240, different encoders can be employed. Additional details of the encoding are discussed in more detail with regard to operations 420 and 425 illustrated in FIG. 4. Additionally, in 540, these separate encodings can be combined as discussed in more detail with regard to operation 430 illustrated in FIG. 4.

In 550, the combined input is consumed by the LLM 260 which has been trained to accept, as an input, a combination of an encoded IVR tree 255 and encoded user prompt. The LLM 260, in combination with the answer generator 270, is configured to generate, based upon the input, intents, slots (entities), actions, and an answer to be provided to the user 202. For example, if the user input was “I want to book a reservation for two people at your restaurant for 6 PM on Friday and I would like a table by the window,” the LLM 260 would identify the intent, slots, and actions and generate an answer to the user prompt.

In certain instances, the generation of an answer may first require the performance of a particular activity, in 560, such as the acquisition of data. An example action could include, for example, gathering data from one or more APIs 265-265N on data that may be required. For example, a call to one API 265A may gather data as to the availability of seating at the time. A call to another API 265B may identify what specific seating is available (e.g., next to the window). Yet a different call could identify additional information such as hours of operation. Another action would be to modify the data structure associated with the restaurant's reservation to accept a particular reservation. Many types of actions are known to be associated with IVR trees 255, and the present chatbot server 210 is not limited as to a particular type of action being performed.

In 570, the output of the LLM 260 and if an action is to be performed, the result of the action, is fed into the trained answer generator 270 to create an answer that will be forwarded to the user 202 in 580. Using the example provided above, the answer could be “we have a table by the window for that time and day, could I have your name and number for the reservation.”Alternatively, the answer generator 270 could create an answer that states “we don't have a table by the window at 7 PM on Friday, but we do have one at 7:30 PM. Would that be acceptable?” Another reply could be “we don't have any tables available Friday between the hours of 6PM and 9 PM, do you want to try another time.” The methodology 500 continues until a determination is made in 590, that the conversation has ended in which case that process proceeds to 595. Although the determination is illustrated as being performed between when the answer is provided in 580 and when the user prompt is received in 510, determination 590 can take place at any point within the methodology 500.

In many instances, the chatbot server 210 implements a multi-turn conversation. For example, an initial question by the user 202 and a response by the chatbot server 210 may lead to a further question by the user 202. In these instances, the chatbot server can retain a “state” of the conversation. As used herein, the “state” includes prior user inputs and, optionally, the answers to those prior user inputs. This state information can then optionally be used to supplement the new user input. In particular, this state information can be used to provide missing entities (slots) that were detected from the IVR tree 255. For example, if the user would like to book a table, the missing slots could be number of guests, special meal requirements, time, etc. In this instance, the LLM 260 would generate a session of questions intended to elicit responses from the user 202 that would contain slot values for the missing slots.

Additionally, in the context of a multi-turn conversation, operations 520 and 530 can optionally be omitted. The state information that is associated with the multi-turn conversation can include an identification (and encoding) of the particular IVR tree 255. Consequently, the need to re-identify the IVR tree 255 may be unnecessary.

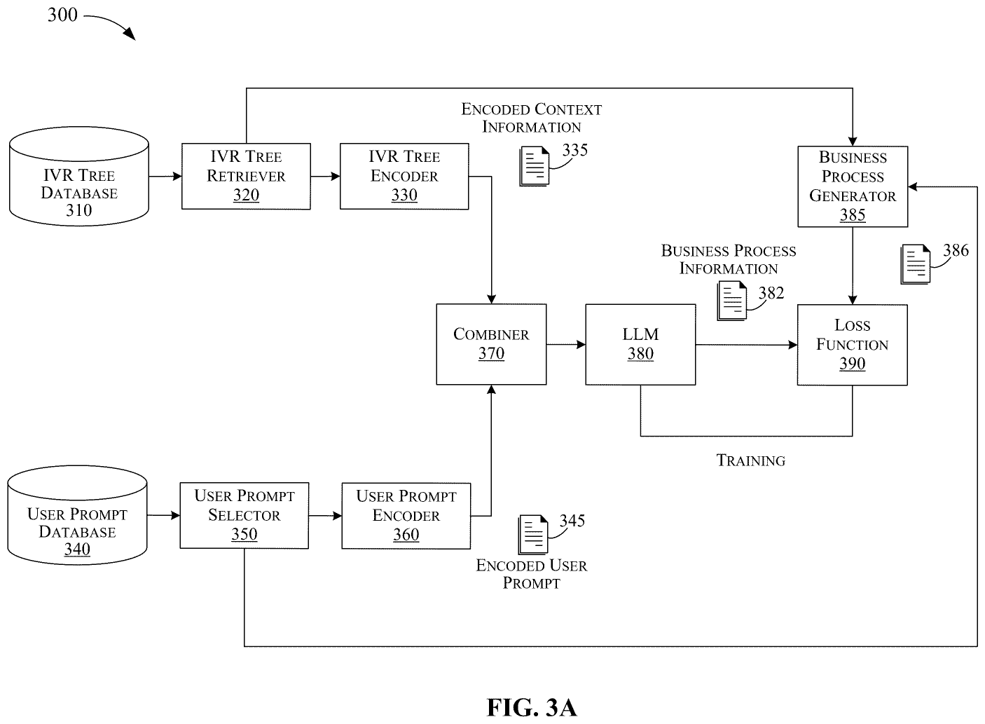

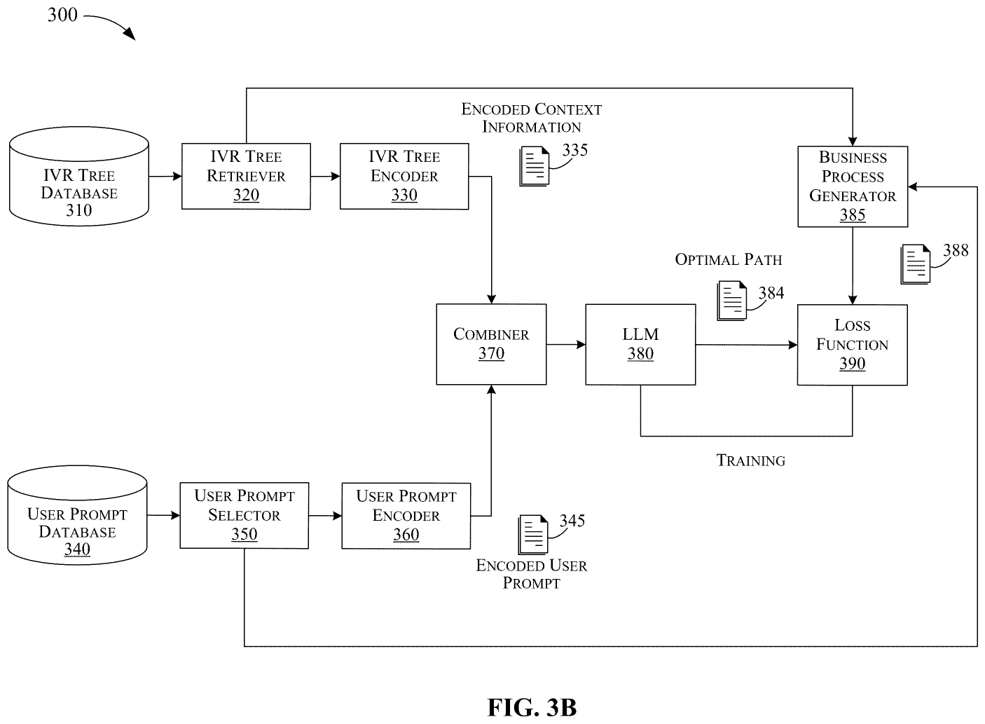

With reference to FIGS. 3A-B and 4, an overview of a chatbot training architecture 300 and general methodology 400 for training a LLM 380 as a chatbot is disclosed. Referring specifically to FIG. 3A and the process of FIG. 4, in block 410, the IVR retriever 320 retrieves/selects a sample or training IVR tree from an IVR tree database 310. The training IVR tree is not limited as to a particular type or complexity. The IVR tree database 310 is a training corpus that contains a multitude of different training IVR trees that are representative of potential IVR trees that currently exist. Additionally, a particular basis for selecting one training IVR tree over another is not necessary as the LLM 380 is likely to be trained using most, if not all, of the training IVR trees contained within the IVR tree database 310 unless a determination is made that the LLM 380 has been sufficiently trained to a point such that additional training using additional IVR trees within the IVR tree database 310 is not required.

In 420, the IVR tree encoder 330 is configured to encode the retrieved training IVR tree in a manner that is usable by the LLM 380. As previously discussed, an IVR tree contains information about nodes of the IVR tree, how the nodes interact, and information contained within the nodes. As is known, IVR trees can be generated/stored in many different formats. For example, the IVR tree could be expressed as a directed graph. Regardless of the format used, the process 400 requires that the training IVR tree be converted, by the IVR tree encoder 330, into a format that the LLM 380 is configured to understand. The encoding of a particular data structure (e.g., the training IVR tree) into a format understandable by a particular LLM 380 is a known process, and the present IVR tree encoder 330 is not limited as to a particular approach. Ultimately, the IVR tree encoder outputs encoded context information 335, with the “context” representing the training IVR tree.

In 415, the user prompt selector 350 retrieves a sample user prompt from the user prompt database 340. The sample user prompt is not limited as to a particular type or complexity. However, the sample user prompt is matched to the particular IVR tree retrieved in block 410. The user prompt database 340 is a training corpus that contains a multitude of different user prompts that can be used with the IVR trees contained within the IVR tree database 310. These sample user prompts can be examples of real user prompts that were associated with a particular IVR tree and/or manually-generated user prompts. For each IVR tree, the user prompt database 340 should contain sufficient user prompts to transit every node and every possible path between the nodes within the IVR tree. Additionally, a particular basis for selecting one user prompt over another user prompt is not necessary as the LLM 380 is likely to be trained using most, if not all, of the user prompts contained within the IVR tree database 310 unless a determination is made that the LLM 380 has been sufficiently trained to a point such that additional training using other user prompts within the user prompt database 310 is not required.

The IVR tree database 310 can also be supplemented with automatically-generated different versions of IVR trees, for example, by using rule-based changes that “mix-and-match” parts of a IVR tree. The user prompt database 340 can also be supplemented with automatically-generated user prompts. These user prompts, for example, could be automatically generated using a LLM specifically trained for the task.

In 425, the user prompt encoder 360 is configured to encode the retrieved user prompt in a manner that is usable by the LLM 380. The process of encoding a user prompt to a form usable by the LLM 380 is known, and the user prompt the present user prompt encoder 360 is not limited as to a particular approach. Typically, such approaches involve performing natural language processing on the user prompt, which can break down the user prompt into tokens, and these tokens can be used as input for the LLM 380. Ultimately, the user prompt encoder 360 outputs encoded user prompt information 345.

In 430, the combiner 370 combines the encoded content information 335 and the encoded user prompt information 345 into an input that will be fed to the LLM 380. The combining of the encoded information that will be subsequently fed into a LLM 380 is a known operation, and the combiner 370 is not limited as to a particular approach. Although illustrated as being separate components, the IVR tree retriever 320, the user prompt selector 350, the IVR tree encoder 330, and the user prompt encoder 360, and combiner 370 can be combined together as one or more components that provide the functionality associated therewith.

In 440, the LLM 380 will use the input provided by the combiner 370 and generate business process information 382. As defined herein, the term “business process information” refers to the intents, slots, actions, and answers that are associated with a particular user prompt. After the LLM 380 has been trained, the business process information 382 is what will be used to provide the functionality of the chatbot 210.

In 450, a loss function will be performed on the generated business process information using the loss function component 390. Many types of loss functions are known, and the chatbot training architecture 300 is not limited as to a particular type of loss function being used. As is known in the art, a loss function is a mathematical function that quantifies inconsistency or error between the actual (also referred to as “predicted”) output of the model (i.e., LLM 380) and the expected output of the model. In this instance, the actual output of the LLM 380 is the predicted business process information 382. The business process generator 385 generates the expected output 386 (i.e., the intended output) of business process information.

The business process generator 385 is not limited as to the manner in which the expected output 386 is generated. In certain instances, the expected output 386 can be manually created for each user prompt. In other instances, the expected output 386 can be generated automatically. Although not limited to this particular approach, an example approach for automatically generating the expected output 386 is described in U.S. Pat. No. 11,637,927, the contents of which are incorporated herein by reference in their entirety.

In 460, after the loss function has been performed, the LLM 380 is trained based upon the results of the comparison between the actual (predicted) output and the expected output. The training of LLMs 380 using a loss function component 390 is a known process, and the chatbot training architecture 300 and methodology 400 is not limited as to a particular manner of performing the training. Depending upon the particular approach used, the methodology can return to 445 in which the same output of the combiner 370 is used to generate new business process information 382 using the trained LLM 380. As is known in the art, this loop can continue until the chatbot training architecture 300 determines that training and retraining the LLM 380 using the particular user prompt no longer provides a desired benefit in which case the process returns to the beginning 405 after which a new user prompt can be selected in 415 or a new IVR tree can be selected in 410.

The process 400 continues until a determination is made, at 470, that the training of the LLM 380 is complete. If the determination is made that the training of the LLM 380 is complete, the process proceeds to 480 in which the LLM 380 is deemed trained and the training of the LLM 380 ends. The manner in which this determination is made is not limited as to a particular approach. Many different approaches can be used to determine when a LLM 380 is “trained” and the chatbot training architecture 300 is not limited as to a particular approach so capable.

Referring to FIGS. 3B and 4, the chatbot training architecture 300 and methodology 400 can also train the LLM 380 using a slightly different approach. Instead of having the LLM 380 generate, as the output, business process information as discussed with regard to FIG. 3A, the LLM 380 can be configured to generate, as actual output, an optimal path 384 in 445. As discussed above, the optimal path 384 represents the predicted path (i.e., as an identification of series of nodes) along the particular IVR tree that would best lead to the proper answer for the particular user prompt being evaluated.

The loss function would then compare the actual (predicted) output (i.e., optimal path 384) generated by the LLM 380 with the expected optimal path 388. As with the expected output 386 discussed with regard to FIG. 3A, the expected path 388 can be manually created for each user prompt or generated automatically. Although not limited to this particular approach, an example approach for automatically generating the expected path 388 is described in U.S. Pat. No. 11,637,927, the contents of which are incorporated herein by reference in their entirety. As with regard to FIG. 3A, the training of the LLM 380 using the loss function component 390 is not limited as to a particular approach.

For the trained LLM 380 to provide the zero shot capabilities, the LLM 380 needs to be able to provide accurate business process information 382 for a particular IVR tree/user prompt combination. While the training of the LLM 380 pursuant to FIG. 3A is necessary, the training of the LLM 380 pursuant to FIG. 3B is not necessary. However, there may be instances in which the training process 400 is slow and the actual (predicted) output 382 and the expected output 386 do not converge well. In these instances, supplementing the training of the LLM 380 pursuant to FIG. 3A with the training of the LLM 380 pursuant to FIG. 3B can improve the speed and/or accuracy in training the LLM 380.

The methodology 400 is not limited in the timing between when the LLM 380 is trained pursuant to FIG. 3A or trained pursuant to FIG. 3B. For example, the training pursuant to FIG. 3B can proceed the training pursuant to FIG. 3A. Alternatively, the training pursuant to FIGS. 3A and 3B can take place in parallel. Ultimately, the methodology 400 ends, in 480, after a determination is made that the LLM 380 can accurately provide the business process information 382 upon the first presentation of user prompt and a IVR tree associated therewith.

In training the LLM 380 in the manner described, intents, slots (entities), actions can be inferred from the training IVR trees. Additionally, possible conversational flows (e.g., the path between the nodes of the training IVR trees and also described as business logic) can also be inferred from a particular training IVR tree coupled with a particular user prompt.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 6, computing environment 600 contains an example of an environment for the execution of at least some of the computer code involved in performing the inventive methods, such as code block 650 for implementing the operations of the chatbot server 210 and chatbot training architecture 300. Computing environment 600 includes, for example, computer 601, wide area network (WAN) 602, end user device (EUD) 603, remote server 604, public cloud 605, and private cloud 606. In certain aspects, computer 601 includes processor set 610 (including processing circuitry 620 and cache 621), communication fabric 611, volatile memory 612, persistent storage 613 (including operating system 622 and method code block 650), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. However, to simplify this presentation of computing environment 600, detailed discussion is focused on a single computer, specifically computer 601. Computer 601 may or may not be located in a cloud, even though it is not shown in a cloud in FIG. 6 except to any extent as may be affirmatively indicated.

Processor set 610 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In certain computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in code block 650 in persistent storage 613.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 611 is the signal conduction paths that allow the various components of computer 601 to communicate with each other. Typically, this communication fabric 611 is made of switches and electrically conductive paths, such as the switches and electrically conductive paths that make up busses, bridges, physical input / output ports and the like. Other types of signal communication paths may be used for the communication fabric 611, such as fiber optic communication paths and/or wireless communication paths.

Volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In computer 601, the volatile memory 612 is located in a single package and is internal to computer 601. In addition to alternatively, the volatile memory 612 may be distributed over multiple packages and/or located externally with respect to computer 601.

Persistent storage 613 is any form of non-volatile storage for computers that is now known or to be developed in the future. The non-volatility of the persistent storage 613 means that the stored data is maintained regardless of whether power is being supplied to computer 601 and/or directly to persistent storage 613. Persistent storage 613 may be a read only memory (ROM), but typically at least a portion of the persistent storage 613 allows writing of data, deletion of data and re-writing of data. Some familiar forms of persistent storage 613 include magnetic disks and solid state storage devices. Operating system 622 may take several forms, such as various known proprietary operating systems or open source Portable Operating System Interface type operating systems that employ a kernel. The code included in code block 650 typically includes at least some of the computer code involved in performing the inventive methods.

Peripheral device set 614 includes the set of peripheral devices for computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some aspects, storage 624 may take the form of a quantum computing storage device for storing data in the form of qubits. In aspects where computer 601 is required to have a large amount of storage (for example, where computer 601 locally stores and manages a large database) then this storage 624 may be provided by peripheral storage devices designed for storing very large amounts of data, such as a storage area network (SAN) that is shared by multiple, geographically distributed computers. Internet-of-Things (IoT) sensor set 625 is made up of sensors that can be used in IoT applications. For example, one sensor may be a thermometer and another sensor may be a motion detector.

Network module 615 is the collection of computer software, hardware, and firmware that allows computer 601 to communicate with other computers through a Wide Area Network (WAN) 602. Network module 615 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 615 are performed on the same physical hardware device. In other aspects (for example, aspects that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any Wide Area Network (for example, the internet) capable of communicating computer data over non-local distances by any technology for communicating computer data, now known or to be developed in the future. In some aspects, the WAN 602 ay be replaced and/or supplemented by local area networks (LANs) designed to communicate data between devices located in a local area, such as a Wi-Fi network. The WAN 602 and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In certain aspects, EUD 603 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. As defined herein, the term “server” means a data processing system configured to share services with one or more other data processing systems.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other aspects, a private cloud 606 may be disconnected from the internet entirely (e.g., WAN 602) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 605 and private cloud 606 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A method, within and by a chatbot system for implementing a chatbot, comprising:
receiving, from a client device, a user prompt associated with a user and directed to the chatbot;
identifying an interactive voice response (IVR) tree associated with the user prompt;
encoding the user prompt and the IVR tree into an encoded input;
causing the encoded input to be consumed by a trained neural model;
generating, by the neural model and using the encoded input, business process information;
generating, by the trained neural model and using the business process information, an answer; and
providing the answer to the client device.

2. The method of claim 1, wherein
the business process information includes at least one intent, at least one slot, and at least one action.

3. The method of claim 2, wherein
the chatbot system is configured to perform the at least one action.

4. The method of claim 1, wherein
the trained neural model is a large language model (LLM).

5. The method of claim 1, wherein
the trained neural model is trained by inputting into the trained neural model a plurality of IVR trees and training user prompts associated therewith,
the trained neural model is configured to generate predicted business process information,
a loss function compares the predicted business process information to expected business process information.

6. The method of claim 5, wherein
the trained neural model is configured to generate a predicted path for a training user prompt associated with a particular training IVR tree, and
the loss function is based upon comparing the predicted path with an expected path.

7. The method of claim 6, wherein
the expected business process information and the expected path are automatically generated.

8. A chatbot system including a computer hardware system for implementing a chatbot, comprising:
a hardware processor configured to initiate the following executable operations:
receiving, from a client device, a user prompt associated with a user and directed to the chatbot;
identifying an interactive voice response (IVR) tree associated with the user prompt;
encoding the user prompt and the IVR tree into an encoded input;
causing the encoded input to be consumed by a trained neural model;
generating, by the neural model and using the encoded input, business process information;
generating, by the trained neural model and using the business process information, an answer; and
providing the answer to the client device.

9. The system of claim 8, wherein
the business process information includes at least one intent, at least one slot, and at least one action.

10. The system of claim 9, wherein
the chatbot system is configured to perform the at least one action.

11. The system of claim 8, wherein
the trained neural model is a large language model (LLM).

12. The system of claim 8, wherein
the trained neural model is trained by inputting into the trained neural model a plurality of IVR trees and training user prompts associated therewith,
the trained neural model is configured to generate predicted business process information,
a loss function compares the predicted business process information to expected business process information.

13. The system of claim 12, wherein
the trained neural model is configured to generate a predicted path for a training user prompt associated with a particular training IVR tree, and
the loss function is based upon comparing the predicted path with an expected path.

14. The system of claim 13, wherein
the expected business process information and the expected path are automatically generated.

15. A computer program product, comprising:
a computer readable storage medium having stored therein program code for implementing a chatbot,
the program code, which when executed by a computer hardware system within a chatbot system, causes the computer hardware system to perform:
receiving, from a client device, a user prompt associated with a user and directed to the chatbot;
identifying an interactive voice response (IVR) tree associated with the user prompt;
encoding the user prompt and the IVR tree into an encoded input;
causing the encoded input to be consumed by a trained neural model;
generating, by the neural model and using the encoded input, business process information;
generating, by the trained neural model and using the business process information, an answer; and
providing the answer to the client device.

16. The computer program product of claim 15, wherein
the business process information includes at least one intent, at least one slot, and at least one action.

17. The computer program product of claim 16, wherein
the chatbot system is configured to perform the at least one action.

18. The computer program product of claim 15, wherein
the trained neural model is a large language model (LLM).

19. The computer program product of claim 15, wherein
the trained neural model is trained by inputting into the trained neural model a plurality of IVR trees and training user prompts associated therewith,
the trained neural model is configured to generate predicted business process information,
a loss function compares the predicted business process information to expected business process information.

20. The computer program product of claim 19, wherein
the trained neural model is configured to generate a predicted path for a training user prompt associated with a particular training IVR tree, and
the loss function is based upon comparing the predicted path with an expected path.
